(19) United States
(12) Patent Application Publication
(10) Pub. No.: US 2010/0193219 A1
(43) Pub. Date: Aug. 5, 2010

(54) TRANSPARENT CONDUCTOR AND METHOD FOR PRODUCING THE SAME

(75) Inventors: Masutatsu MASHIMO, Tokyo (JP); Noriyuki YASUDA, Tokyo (JP); Kazuhisa INABA, Tokyo (JP)

Correspondence Address: OLIFF & BERRIDGE, PLC, P.O. BOX 320850, ALEXANDRIA, VA, 22320-4850, US

(73) Assignee: TDK CORPORATION, Tokyo (JP)

(21) Appl. No.: 12/691,295

(22) Filed: Jan. 21, 2010

(30) Foreign Application Priority Data
Jan. 30, 2009 (JP) 2009-020735

(51) Int. Cl. H01B 5/00; B05D 5/12

(52) U.S. Cl. 174/126.1; 427/108

(57) ABSTRACT

A transparent conductor provided with a conductive layer that contains a cured Si oxide body and a conductive powder, characterized in that the conductive powder is fixed by the cured Si oxide body.

### BACKGROUND OF THE INVENTION

1. Field of the Invention

The present invention relates to a transparent conductor and to a method for producing it.

2. Related Background Art

LCDs, PDPs, organic ELs, touch panels and the like employ transparent electrodes, and transparent conductors are used in such transparent electrodes.

One known form for conventional transparent conductors employs a combination of transparent conductive particles and a binder resin. Such transparent conductors are known that are fabricated by coating of a material comprising transparent conductive particles and a thermoplastic resin into the form of a film. Tin oxide, indium-tin complex oxides, indium oxide, zinc oxide, zinc-antimony complex oxides and the like are used for the transparent conductive particles.

As such transparent conductors there have been proposed, for example, transparent conductors formed from tin-doped indium oxide fine powder, as a transparent conductive oxide material, and a thermoplastic resin (see Japanese Unexamined Patent Publication HEI No. 11-227740).

### SUMMARY OF THE INVENTION

When a transparent conductor is used in a resistance film-type touch panel (hereinafter referred to as “touch panel”), it is pressed with a touch pen or the like causing flexure of the transparent conductor, so that it contacts with another transparent conductor or element situated below it and conduction takes place at the contact section, allowing the pressed location to be detected. In this case, the transparent conductor must be able to recover its original shape after the pressing force is released.

However, when transparent conductors employing such binder resins are repeatedly subjected to mechanical load by use in touch panels, they undergo alterations in the original shape and may consequently exhibit fluctuation in resistance.

It is therefore an object of the present invention to provide a transparent conductor that exhibits minimal alterations in physical properties such as physical shape deformation or resistance fluctuation even with repeated use so as to meet the demands described above, as well as a method for producing it.

In order to achieve this object, the invention provides a transparent conductor comprising a conductive layer that contains a cured Si oxide body and a conductive powder, characterized in that the conductive powder is fixed by the cured Si oxide body.

The transparent conductor of the invention comprises a conductive layer having conductive powder supported by a cured Si oxide body, instead of a conventional binder resin. Because thermoplastic resins ordinarily used as binder resins are prone to deformation and swelling, conventional transparent conductors easily undergo deformation from their original shapes and thus exhibit fluctuating resistance values. A cured Si oxide body, on the other hand, is resistant to such deformation of thermoplastic resins and has excellent strength to withstand repeated use. Thus, the transparent conductor of the invention is resistant to physical alterations such as shape deformation and resistance fluctuation even when subjected to repeated mechanical load, and can maintain performance during production even when used for prolonged periods.

The transparent conductor preferably has a cured Si oxide body content of 3 wt %-60 wt % in the conductive layer, based on the total weight of the conductive layer. By providing a conductive layer having such a construction it is possible to obtain a transparent conductor with an even more notable effect.

The transparent conductor preferably further comprises a resin layer made of a resin, and a base, with a laminated structure comprising the base, the resin layer and the conductive layer in that order. The transparent conductor is not limited to use for touch panels, but also for LCDs, PDPs, organic ELs, antistatic devices, heating units, antennas, electromagnetic shields, switches, optical filters, transparent electrodes and the like.

Also, the resin layer in the transparent conductor is preferably composed of a plurality of layers made of resins with different glass transition points (Tg). By providing a plurality of resin layers made of resins with different Tg values, it is possible to selectively form resin layers with excellent adhesiveness on the base and the conductive layer, and to further improve the overall adhesiveness between layers and durability. In particular, if the layer composed of the resin with the lowest glass transition point (Tg) among the plurality of resin layers is situated between the base and the conductive layer, this resin layer can function as a stress relaxation layer to reduce the load on the conductive layer, thus further inhibiting shape deformation and physical alteration, while also improving the durability. Furthermore, the resin layer is preferably adjacent to the base for maximum practical advantage.

The glass transition point (Tg) of the resin composing the layer with the resin of lowest glass transition point (Tg) in the transparent conductor is preferably −100° C.-20° C. Such a construction will allow the layer composed of the resin with the lowest glass transition point (Tg) to more suitably function as a stress relaxation layer, so that the effect described above can be obtained more prominently.

The cured Si oxide body in the transparent conductor is preferably formed from a silazane or siloxane. Such a transparent conductor allows the effect described above to be satisfactorily obtained, while facilitating formation of the conductive layer for more convenient production.

The present invention also provides a method for producing a transparent conductor provided with a conductive layer comprising a cured Si oxide body and a conductive powder wherein the conductive powder is fixed in the cured Si oxide body, the method being characterized by reacting the silazane or siloxane in the conductive material comprising the conductive powder and the silazane or siloxane to form the cured Si oxide body, to obtain the conductive layer.

According to the production method of the invention it is possible to obtain a transparent conductor that is resistant to physical alterations such as shape deformation and resistance fluctuation even when subjected to repeated mechanical load, and that can maintain performance during production even when used for prolonged periods.

According to the invention it is possible to provide a transparent conductor that has low physical alteration such as shape deformation and resistance fluctuation even when subjected to repeated mechanical load, and can maintain performance during production even when used for prolonged periods, as well as a method for producing it.

### BRIEF DESCRIPTION OF THE DRAWINGS

FIG. 1 is a schematic cross-sectional view showing a preferred embodiment of a transparent conductor according to the invention.

FIG. 2 is a schematic cross-sectional view showing a preferred embodiment of a transparent conductor according to the invention.

### DESCRIPTION OF THE PREFERRED EMBODIMENTS

Preferred embodiments of the invention will now be explained in detail, with reference to the accompanying drawings as necessary. Throughout the explanation of the drawings, corresponding elements will be referred to by like reference numerals and will be explained only once.

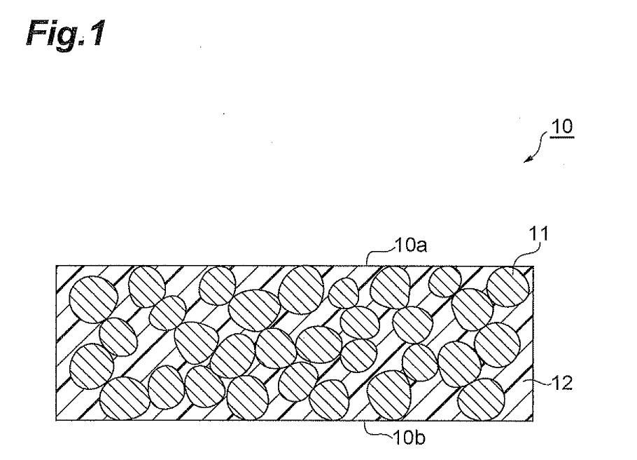

The transparent conductor of this embodiment is provided with a conductive layer that contains a cured Si oxide body and a conductive powder, characterized in that the conductive powder is fixed by the cured Si oxide body. The term “fixed” indicates a state in which the inorganic material composed of the cured Si oxide body 12 is dispersed in the voids between the plurality of conductive particles composing the conductive powder 11 to form a three-dimensional matrix, as shown in FIG. 1, or wherein the cured Si oxide body 12 functions as a binder to support the conductive powder 11.

[Conductive Layer]

A conductive layer according to a preferred embodiment will be explained first. FIG. 1 is a schematic cross-sectional view showing a transparent conductor according to a preferred embodiment. The transparent conductor of this embodiment is characterized by being composed of only the conductive layer 10, the conductive layer 10 comprising the cured Si oxide body 12 and conductive powder 11, and by the conductive powder 11 being fixed by the cured Si oxide body 12.

(Cured Si Oxide Body)

The cured Si oxide body is a compound represented by the chemical formula SiO₂, and it is an oxide obtained, for example, by silazane de-deammoniation reaction or siloxane dehydration reaction. Using a cured Si oxide body can eliminate the problems of thermoplastic resin deformation and swelling in a conductive layer employing a conventional thermoplastic resin as the binder resin. That is, the conductive layer comprising the cured Si oxide body exhibits more excellent strength compared to a conductive layer employing a conventional thermoplastic resin as a binder resin, and also lower shape deformation and reduced resistance fluctuation even when subjected to repeated mechanical load.

The content of the cured Si oxide body in the conductive layer is preferably 3 wt %-60 wt % and more preferably 5 wt %-20 wt % based on the total weight of the conductive layer. If the cured Si oxide body content is less than 3 wt % the strength of the conductive layer may not be at the required ideal level, and if it is greater than 60 wt % the ideal conductivity may not be obtained.

The cured Si oxide body is preferably formed from a silazane or siloxane. Such a cured Si oxide body can form a dense three-dimensional structure around the conductive powder, thus firmly supporting the conductive powder. A transparent conductor having this construction will therefore be resistant to deterioration such as loss of the conductive powder, and will exhibit excellent durability.

The cured Si oxide body is more preferably formed from silazane. An example of a reaction for forming the cured Si oxide body from silazane is represented by formula (I) below.

—(SiH₂NH)ₙ-+2H₂O→—(SiO₂)ₙ—+NH₃+2H₂ (I)

If the precursor for the cured Si oxide body is a compound such as a silazane having an amino group as the reactive group, the reactivity in the reaction for production of the cured Si oxide body will tend to be higher. A precursor having an amino group as the reactive group will also allow a three-dimensional network structure to be formed by especially pure, strong bonds represented by Si—O—Si, thus allowing formation of a cured Si oxide body that can firmly support the conductive powder.

When the cured Si oxide body is formed from a silazane, the conductive layer containing the cured Si oxide body will allow the ammonia (NH₃) produced by deammoniation reaction of the silazane to remain in the cured Si oxide body as residue. Conductive powder is usually prone to loss of conductivity by acids, but ammonia residue remaining in the cured Si oxide body of the conductive layer can reduce the effects of acids as a result of the basic ammonia, thus stabilizing the conductive powder. A transparent conductor with a conductive layer comprising cured Si oxide body formed from a silazane, therefore, can inhibit resistance fluctuation due to deterioration of the conductive powder with time and thus exhibit excellent durability that can withstand prolonged use. From this viewpoint, ammonia may even be separately added to the cured Si oxide body.

As examples of siloxanes there may be mentioned alkoxysiloxane oligomers such as methylmethoxysiloxane or ethylethoxysiloxane, and reactive polysiloxanes in which the reactivity of a silanol, epoxy or methacryloyl group is imparted to dimethylpolysiloxane, methylphenylpolysiloxane or the like. Alkoxysiloxane oligomers are preferred among these from the viewpoint of the strength of the obtained conductive layer.

As examples of silazanes there may be mentioned tetramethyldisilazane, hexamethyldisilazane, perhydropolysilazane and the like. Perhydropolysilazanes are preferred among these from the viewpoint of high reactivity and excellent curability.

(Conductive Powder)

The conductive powder is not particularly restricted so long as it is composed of transparent conductive particles, but the particles are preferably composed of a transparent conductive oxide material. A transparent conductive oxide material is a material which is composed mainly of a metal oxide and exhibits transparency and conductivity. As examples of transparent conducting materials there may be mentioned metal oxides such as indium oxide, tin oxide or zinc oxide, indium oxide doped with one or more elements selected from the group consisting of tin, zinc, tellurium, silver, gallium, zirconium, hafnium and magnesium; tin oxide doped with one or more elements selected from the group consisting of antimony, zinc and fluorine; zinc oxide doped with one or more elements selected from the group consisting of aluminum, gallium, indium, boron, fluorine and manganese; and titanium oxide doped with niobium or tantalum.

The conductive powder is preferably conductive powder with water resistance. A “conductive powder with water resistance” is a conductive powder that does not exhibit deterioration such as increased resistance due to moisture. Specifically, the water-resistant conductive powder will differ depending on the transparent conductive oxide material. That is, when the transparent conductive oxide material is indium oxide or an indium complex oxide obtained by doping indium oxide with one or more elements selected from the group consisting of tin, zinc, tellurium, silver, gallium, zirconium, hafnium and magnesium, the water-resistant conductive powder may be one that produces a pH of 3 or higher in a mixture comprising the conductive powder at 1 wt %, or one that produces a pH of lower than 3 in a mixture comprising the conductive powder at 1 wt % and that has a halogen element concentration of no greater than 0.2 wt %.

In the case of tin oxide or a tin complex oxide obtained by doping tin oxide with one or more elements selected from the group consisting of antimony, zinc and fluorine, the water-resistant conductive powder may be one that produces a pH of 1 or higher in a mixture comprising the conductive powder at 1 wt % and that has a halogen element concentration of no greater than 1.5 wt %. In the case of zinc oxide or a zinc complex oxide obtained by doping zinc oxide with one or more elements selected from the group consisting of aluminum, gallium, indium, boron, fluorine and manganese, the water-resistant conductive powder may be one that produces a pH of 4-9 in a mixture comprising the conductive powder at 1 wt %. Here, a “mixture” is a mixture comprising the conductive powder and water.

The transparent conductor comprising a conductive layer that contains such water-resistant conductive powder and a cured Si oxide body can prevent fluctuation in the resistance value with time even in high humidity environments.

Adjustment of the pH of the mixture comprising the conductive powder at 1 wt % can be accomplished by removing the impurities by rinsing, neutralization or heating, for example, but it is preferably accomplished by neutralization and especially by neutralization using ammonia water. Using this method allows easy control of the pH of the mixture while also selectively eluting chlorine from the conductive powder and effectively reducing the chlorine concentration of the conductive powder.

The mean particle size of the conductive powder is preferably 10 nm-80 nm. A mean particle size of less than 10 nm will tend to result in lower stability for the conductivity of the transparent conductor, compared to a mean particle size of 10 nm or greater. Specifically, the transparent conductor of this embodiment exhibits its conductivity due to oxygen defects produced in the conductive powder, and with a conductive powder particle size of less than 10 nm the reactivity for oxygen is increased, tending to result in fewer oxygen defects and potentially preventing ideal conductivity. On the other hand, a mean particle size of greater than 80 nm increases the light scattering in the wavelength range of visible light compared to a mean particle size of up to 80 nm, such that the transmittance and haze value of the transparent conductor in the wavelength range of visible light may not be the required ideal values.

The area-to-weight ratio of the conductive powder is preferably 10-50 m²/g. An area-to-weight ratio of less than 10 m²/g will increase the light scattering of visible light, thus potentially resulting in optical characteristics outside of the ideal range, while an area-to-weight ratio of greater than 50 m²/g may cause the stability of the transparent conductor to be less than ideal. The area-to-weight ratio referred to here is the value measured using an area-to-weight ratio measuring apparatus (Model NOVA2000 by Quantachrome Instruments) after vacuum drying the sample at 300° C. for 30 minutes.

The conductive powder content in the conductive layer is preferably 40 wt %-97 wt % based on the total weight of the conductive layer. A content of less than 40 wt % may not result in the ideal low resistance required for the transparent conductor, while a content of greater than 97 wt % may prevent the mechanical strength of the transparent conductor from reaching the required ideal high strength.

The conductive powder can be produced in the following manner. The conductive powder used in this case was indium oxide doped with tin (hereinafter referred to as “ITO”).

First, indium chloride and tin chloride were subjected to neutralization treatment using an alkali for coprecipitation (precipitation step). The salt by-product was removed by decantation or centrifugal separation. The obtained coprecipitate was dried and the dried product was treated by atmospheric firing and pulverizing. The conductive powder is produced in this manner. The firing treatment is preferably carried out in a nitrogen atmosphere or a rare gas atmosphere such as helium, argon or xenon, from the viewpoint of controlling oxygen defects. The firing is preferably carried out in a reducing atmosphere. In a reducing atmosphere, hydrogen or carbon monoxide may be used as reducing agents in nitrogen and rare gas, or a commonly used reducing agent may be used.

(Other Components)

The conductive layer may also contain various additives in addition to the cured Si oxide body and conductive powder, for the purpose of modifying the resistance value or mechanical properties of the conductive layer. As examples of additives there may be mentioned flame retardants, ultraviolet absorbers, coloring agents, binders, coupling agents, fillers, plasticizers, surfactants and the like. Needless to mention, these amounts in the conductive layer are on a level such that the cured Si oxide body and conductive powder remain the major components.

[Resin Layer and Base]

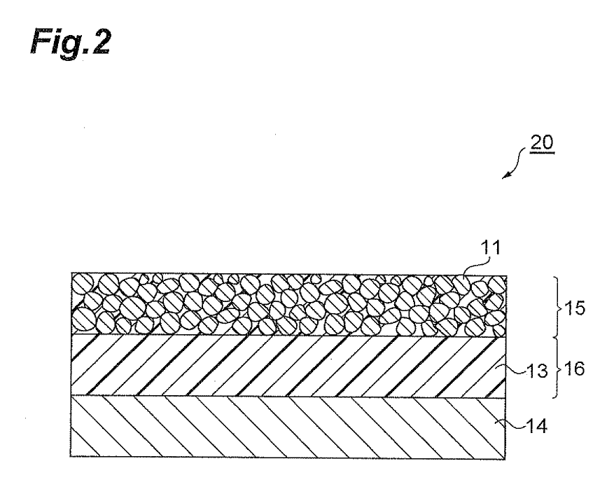

The transparent conductor of this embodiment may have a structure with a resin layer or base laminated together with the conductive layer. As an example of a transparent conductor comprising a base, resin layer and conductive layer there may be mentioned the transparent conductor shown in FIG. 2. The transparent conductor 20 shown in FIG. 2 has a construction with a base 14, a resin layer 16 composed of a resin 13 and a conductive layer 15 laminated in that order. The conductive layer 15 is the same as the conductive layer 10 of the embodiment described above.

First, the resin layer 16 has the function of an adhesive layer for bonding between the base and conductive layer, as well as a function as a stress relaxation layer against pressing force through the transparent conductor that causes bending, and the function of inhibiting shape deformation of the transparent conductor. From the viewpoint of adequately exhibiting the function as a stress relaxation layer, the resin layer 16 is more preferably provided adjacent to the conductive layer 15, as shown in FIG. 2.

The resin composing the resin layer may be a resin obtained by curing a photocuring compound, thermosetting compound, electron beam-curing compound or the like. A photocuring compound is an organic compound that cures under light, a thermosetting compound is an organic compound that cures under heat, and an electron beam-curing compound is an organic compound that cures under an electron beam as a high energy ray. These organic compounds are included in the precursor serving as the starting material for the resin layer 16, and specifically there may be mentioned monomers, dimers, trimers and oligomers that can form resin layers. Preferred among these resins are resins obtained by curing photocuring compounds, from the viewpoint of facilitating control of the curing reaction and shortening the reaction time.

The resin layer 16 may be composed of a plurality of layers made of resins with different glass transition points (Tg). The layer composed of the resin with the lowest glass transition point (Tg) among these layers is most preferably adjacent to the base 14. In a resin layer having such a construction, the resin with a high glass transition point functions as the adhesive layer while the resin with a low glass transition point functions as the stress relaxation layer, so that the two functions of an adhesive layer and a stress relaxation layer can be simultaneously exhibited in an efficient manner. Thus, a transparent conductor comprising such a resin layer 16 has excellent mechanical strength due to the excellent adhesion between layers, while also being resistant to shape deformation and physical alterations by prolonged use.

The resin layer 16 preferably has a layer composed of a resin with a glass transition point (Tg) of −100° C. to 20° C., and more preferably it has a layer composed of a resin with a Tg of −70° C. to 0° C. When the resin layer 16 comprises a plurality of layers as explained above, the glass transition point of the resin composing the layer with the lowest glass transition point (Tg) is preferably −100° C. to 20° C. and more preferably −70° C. to 0° C. A resin layer 16 having such a construction will tend to have even more excellent function as a stress relaxation layer. If the glass transition point of the resin composing the layer with the lowest glass transition point is below −100° C., the strength of the resin layer may not be sufficient, and if it is higher than 20° C. the function as a stress relaxation layer may not be sufficiently obtained.

The base 14 is not particularly restricted so long as it is made of a material that is transparent to visible light, and it may be a known clear film. As specific examples for the base 14 there may be mentioned polyester films such as polyethylene terephthalate (PET), polyolefin films such as polyethylene or polypropylene, polycarbonate film, acrylic films, norbornane films (such as ARTON by JSR or ZEONOR by Zeon Corp.), and polyethersulfone (PES). Glass may also be used as the base 14 instead of a resin film.

[Method for Producing Transparent Conductor]

The method for producing the transparent conductor of this embodiment is not particularly restricted so long as it allows production of a transparent conductor having the construction described above, and a preferred example is a method of using a conductive material comprising conductive powder and a silazane or siloxane and reacting the silazane or siloxane in the conductive material to form a cured Si oxide body to obtain the conductive layer.

According to this production method it is possible to obtain a transparent conductor that is resistant to physical alterations such as shape deformation and resistance fluctuation even when subjected to repeated mechanical load, and can maintain performance during production even when used for prolonged periods. Furthermore, by forming a cured Si oxide body from the silazane or siloxane it is possible to firmly support the conductive powder since a three-dimensional structure of Si oxide is densely formed around the conductive powder. A transparent conductor produced by such a production method will therefore be resistant to deterioration such as loss of the conductive powder, and will exhibit excellent durability.

In the production method, the conductive layer is more preferably obtained by reacting the silazane in a conductive material comprising conductive powder and a silazane, to form the cured Si oxide body. By forming the cured Si oxide body from a silazane, the ammonia produced by deammoniation reaction of the silazane becomes included in the cured Si oxide body, as mentioned above, so that the conductive powder is stabilized by the ammonia in the obtained conductive layer. A transparent conductor produced by a production method using a silazane, therefore, can inhibit resistance fluctuation due to deterioration of the conductive powder with time and thus exhibit excellent durability that can withstand prolonged use.

The conductive material used may be one having the conductive powder and the silazane or siloxane dispersed in a liquid (if necessary with other additives). A layer of the conductive powder placed on a base or the like may be coated or impregnated with a solution containing the silazane or siloxane (if necessary with other additives).

Formation of the conductive layer in this method for producing a transparent conductor may accomplished, specifically, by the following production method 1 or production method 2.

(Production Method 1)

In production method 1, first the conductive powder, silazane or siloxane and other additives as necessary are dispersed in the liquid to obtain a conductive material. The liquid used to disperse the components may be a saturated hydrocarbon such as hexane, an aromatic hydrocarbon such as toluene or xylene, a ketone such as acetone, methyl ethyl ketone, isobutyl methyl ketone or diisobutylketone, an ester such as ethyl acetate or butyl acetate, an ether such as tetrahydrofuran, dioxane or diethyl ether, or an amide such as N,N-dimethylacetamide, N,N-dimethylformamide or N-methylpyrrolidone.

The conductive material is then coated onto one side of the base. The method of coating the conductive material onto the base is not particularly restricted and may be any known method. As examples there may be mentioned a reverse roll method, direct roll method, blade method, knife method, extrusion method, nozzle method, curtain method, gravure roll method, bar coating, dip method, kiss coat method, spin coating, squeeze method or spray method.

The “base” used in this production method serves as a surface for formation of the conductive layer, and it will hereinafter be referred to as the conductive layer-forming base. The conductive layer-forming base may be, for example, glass, a film of polyester, polyethylene or polypropylene, or any of various plastic bases.

After coating of the conductive material, the liquid is removed by volatilization if necessary and the silazane or siloxane in the conductive material is reacted to form a cured Si oxide body. This results in formation of a conductive layer on one side of the conductive layer-forming base.

The reaction conditions for reaction of the silazane or siloxane to form the cured Si oxide body are preferably reaction for 1 hour to several weeks at a temperature of 20° C.-120° C. and a humidity of 5%-95% RH.

(Production Method 2)

In production method 2, first the conductive powder is placed on the conductive layer-forming base. A fix layer for fixing of the conductive powder on the conductive layer-forming base may be provided on the conductive layer-forming base beforehand. If a fix layer is provided, it will be possible to firmly fix the conductive powder on the conductive layer-forming base, thus facilitating placement of the conductive powder. The fix layer is preferably a layer composed of polyurethane or silicone resin, for example.

For fixing of the conductive powder on the conductive layer-forming base, a compression layer may be formed by compressing the conductive powder toward the conductive layer-forming base side. The compression may be accomplished with a sheet press, roll press or the like. In this case as well, it is preferred to provide a fix layer on the conductive layer-forming base beforehand. This will allow the conductive powder to be more firmly fixed. The conductive layer-forming base used may be the same as in production method 1 described above.

Next, a solution containing a silazane or siloxane (with other additives as necessary) is coated onto the conductive powder that has been placed on the conductive layer-forming base (on one side of the compression layer). The solution containing the silazane or siloxane penetrates into the voids of the placed conductive powder, so that the aforementioned conductive material is obtained. The solvent in the solution containing the silazane or siloxane may be, for example, an aromatic hydrocarbon such as toluene or xylene or an ether such as tetrahydrofuran, dioxane or diethyl ether.

After the solvent has been removed if necessary by volatilization or the like, the silazane or siloxane in the conductive material is reacted to form a cured Si oxide body. This results in formation of a conductive layer on one side of the conductive layer-forming base. The solution containing the silazane or siloxane is preferably coated onto the compression layer of the conductive powder (green compact layer) in this manner to obtain a high strength transparent conductor with higher electric conductivity.

After the conductive layer has been formed by production method 1 or production method 2, the conductive layer-forming base may be removed if necessary, or the conductive layer-forming base may be removed after lamination of the resin layer 13 or base 14, to obtain a transparent conductor. The method of laminating the resin layer 13 or base 14 is not particularly restricted, and any known method may be employed.

The conductive layer-forming base used to form the conductive layer during production of the transparent conductor may be directly used as the base for the transparent conductor so long as this does not present any particular inconvenience for use as the transparent conductor. When the transparent conductor 20 having the construction shown in FIG. 2 is formed, the laminated body comprising the resin layer 13 formed on the base 14 may be used as the conductive layer-forming base for direct formation of a conductive layer on the resin layer 13.

### EXAMPLES

The present invention will now be explained in greater detail through the following examples, with the understanding that these examples are in no way imitative on the invention.

### Example 1

First, a polyethylene terephthalate (PET) film (product of Toray Co., Ltd., 50 μm thickness) provided with a fix layer (product of Panasonic Electric Works Co., Ltd.) was coated with an ITO dispersed coating solution comprising ITO powder and ethanol (ITO powder mean particle size: 30 nm, solid concentration: 25%) by bar coating. After coating, the ethanol was volatilized off and the ITO powder was roll pressed to fix it on the PET film, to form a compression layer comprising compressed ITO powder.

Next, a coating solution comprising perhydropolysilazane and dibutyl ether was coated onto the compression layer by bar coating for impregnation into the compression layer. After volatilizing off the dibutyl ether, it was allowed to stand for 24 hours in an atmosphere with a temperature of 100° C. and a humidity of 95% for reaction of the perhydropolysilazane, to form a conductive layer containing ITO powder and a cured Si oxide body comprising perhydropolysilazane.

A coating solution comprising an adhesive material was then coated onto the conductive layer by bar coating. The adhesive material coating solution used was prepared by mixing 20 parts by weight of a butyl acrylate polymer (product of Negami Chemical Industrial Co., Ltd.) with 80 parts by weight of methyl ethyl ketone. After coating the adhesive material coating solution, the methyl ethyl ketone was volatilized off to form a resin layer.

A polyethylene terephthalate (PET) film (product of Teijin-DuPont Films, 100 μm thickness) was then contact bonded onto the resin layer, and the initially used PET film (50 μm-thick PET film) was released. This procedure produced a transparent conductor having a resin layer and conductive layer formed in that order on a base (100 μm-thick PET film).

### Example 2

A transparent conductor was obtained by the same production method as Example 1, except that prebaking was performed at a temperature of 40° C. for 5 minutes before standing for 24 hours in the 100° C., 95% humidity atmosphere.

### Example 3

A transparent conductor was obtained by the same production method as Example 1, except that an ethylethoxysiloxane oligomer was used instead of perhydropolysilazane.

### Comparative Example 1

A transparent conductor was obtained by the same production method as Example 1, except that a polymethyl methacrylate polymer was used instead of perhydropolysilazane.

### Comparative Example 2

An ITO dispersed coating solution comprising 23 parts by weight of ITO powder (mean particle size: 30 nm), 7 parts by weight of a polymethyl methacrylate solution (solid content: 30%) and 70 parts by weight of methyl ethyl ketone (MEK) was coated onto a polyethylene terephthalate (PET) film (product of Teijin-DuPont Films, 100 μm thickness, trade name: HLEW) by bar coating. After coating, the MEK was volatilized off and roll pressing was carried out to obtain a transparent conductor.

[Evaluation of Transparent Conductor]

(Evaluation of Transparent Conductor Resistance)

The electrical resistance was evaluated in the manner described below for the transparent conductors obtained in Examples 1-3 and Comparative Examples 1-2. First, a four-terminal four-point probe surface resistance meter (MCP-T600, product of Mitsubishi Chemical Corp.) was used to measure the electrical resistance at pre-established measuring points, and the measured value was recorded as the initial resistance value. Next, the transparent conductor was allowed to stand for 10 minutes in an environment at 120° C. and then removed, and upon subsequently lowering the temperature of the transparent conductor to room temperature, the electrical resistance value was again measured at the measuring points established before heating and recorded as the post-heating electrical resistance value. The change in the post-heating resistance value with respect to the initial resistance value was calculated and recorded as the change in resistance. The results are shown in Table 1.

TABLE 1

| | Initial resistance | Resistance value | |
|---|---|---|---|
| | value | after test | Change in |
| | (kΩ/□) | (kΩ/□) | resistance |
| Example 1 | 0.93 | 1.13 | 1.22 |
| Example 2 | 0.95 | 1.09 | 1.15 |
| Example 3 | 0.90 | 1.11 | 1.23 |
| Comp. Ex. 1 | 1.13 | 2.68 | 2.37 |
| Comp. Ex. 2 | 2.58 | 7.02 | 2.72 |

Table 1 shows that low change in resistance was obtained in Examples 1-3 wherein the conductive powder was fixed in the cured Si oxide body, thus demonstrating that the performance at the time of production can be maintained even with prolonged use. In contrast, a high change in resistance was confirmed in Comparative Example 1 and Comparative Example 2, wherein the conductive powder was dispersed in the resin (polymethyl methacrylate polymer).

What is claimed is:

1. A transparent conductor provided with a conductive layer that contains a cured Si oxide body and a conductive powder,
characterized in that the conductive powder is fixed by the cured Si oxide body.

2. A transparent conductor according to claim 1, characterized in that the cured Si oxide body content in the conductive layer is 3 wt %-60 wt % based on the total weight of the conductive layer.

3. A transparent conductor according to claim 1, characterized by further comprising a resin layer made of a resin, and a base.

4. A transparent conductor according to claim 3, characterized by having a structure with the base, resin layer and conductive layer laminated in that order.

5. A transparent conductor according to claim 3, characterized in that the resin layer is composed of a plurality of layers made of resins with different glass transition points (Tg).

6. A transparent conductor according to claim 5, characterized in that the layer with the lowest glass transition point (Tg) among the resin layers is adjacent to the base.

7. A transparent conductor according to claim 5, characterized in that the glass transition point (Tg) of the resin composing the layer with the resin of lowest glass transition point (Tg) in the transparent conductor is −100° C.-20° C.

8. A transparent conductor according to claim 1, characterized in that the cured Si oxide body is formed from silazane or siloxane.

9. A method for producing a transparent conductor provided with a conductive layer comprising a cured Si oxide body and a conductive powder wherein the conductive powder is fixed in the cured Si oxide body,
the method being characterized by reacting the silazane or siloxane in the conductive material comprising the conductive powder and the silazane or siloxane to form the cured Si oxide body, to obtain the conductive layer.
